(19) United States
(12) Patent Application Publication
(10) Pub. No.: US 2002/0145815 A1
(43) Pub. Date: Oct. 10, 2002

(54) Optical head device

(76) Inventors: Katsuya Moriyama, Nagano (JP); Hisahiro Ishihara, Nagano (JP); Masao Takemura, Nagano (JP)

Correspondence Address: REED SMITH LLP, 375 PARK AVENUE, NEW YORK, NY, 10152, US

(21) Appl. No.: 10/098,885

(22) Filed: Mar. 14, 2002

(30) Foreign Application Priority Data
Mar. 15, 2001 (JP) 2001-73269

(51) Int. Cl. G02B 7/02; G02B 3/02; G02B 13/18; G11B 5/48; G11B 21/16; G11B 7/00

(52) U.S. Cl. 359/819; 359/824; 359/719; 360/240; 369/44.11; 369/44.14

(57) ABSTRACT

In accordance with the invention, an optical head device comprises a light source, a light receiving element, an optical system that guides light emitted by the light source to an optical recording medium and also guides the light reflected from the optical recording medium to the light receiving element and a base on which the light source, the light receiving element and optical elements constituting the optical system are mounted. An element holder composed of a photosensitive glass is mounted on the base. The element holder has a positioning portion(s) therein for at least one of the optical elements. The base has openings therein at locations through which the optical elements can be assessed from the back thereof.

### CROSS-REFERENCE TO RELATED APPLICATIONS

This application claims priority of Japanese Application No. 2001-73269, filed Mar. 15, 2001, the complete disclosure of which is hereby incorporated by reference.

### BACKGROUND OF THE INVENTION

1. Field of the Invention

The present invention relates to an optical head device which is used for the recording and reproduction of optical recording media such as CDs (compact disks) and DVDs (digital versatile disk). More specifically, the present invention relates to the positioning of a light source, a light receiving element, and various optical elements in the above kind of optical head device.

2. Description of the Related Art

An optical head device used for the recording/reproduction of optical recording media such as CDs and DVDs comprises of a semiconductor laser as a light source for emitting laser light, a light detector for receiving the light which is emitted by the semiconductor laser and reflected on the optical recording medium, various optical elements including a mirror, which are arranged between the semiconductor laser and the optical detector to guide the emitted light or the reflected light, and an objective lens for converging the emitted light guided by the optical elements on the optical recording medium. These elements are mounted onto a frame which is composed of a resin or a metal such as aluminum.

The optical elements are first adjusted in their positioning and fixed with an adhesive on a fiducial plane of the frame. The positioning requires high precision of several μm or less. Therefore, high precision is also needed for the processing precision (a die precision) of the fiducial plane of the frame. Thus, the processing of a die of a frame requires much time and effort. In particular, when a die for multiple yields is used, the precision of each needs to be the same. This results in a high die manufacturing cost.

When a resin frame is used, the displacement of the mounted optical elements, which is caused by a change in the thermal expansion of the resin due to the temperature change, is greater than the displacement caused while using a metallic frame. Consequently, a reliability of the device is degraded. Further, since the resin frame is poor in sticking to the adhesive, compared to the metallic frame, an additional processing like that of creating a rough surface is needed.

### OBJECTIVES OF THE PRESENT INVENTION

The objectives of the present invention include that, in addition to the frame, an element holder may be manufactured so that the optical elements can be positioned and bonded therein, and this element holder may be mounted on the frame or a wiring board placed on the frame. If the element holder can be manufactured precisely, the precision of the frame does not affect the positional precision of the optical elements. To manufacture an element holder precisely, a photosensitive glass may be used because of its property of a small change in thermal expansion caused due to an ambient change, and also its high processing precision.

A primary objective of the present invention is to provide an optical head device in which the optical elements can be positioned precisely by using an element holder composed of a photosensitive glass.

### SUMMARY OF THE INVENTION

To achieve the above objectives, the present invention comprising of a light source, a light receiving element, an optical system that guides light emitted by the light source to an optical recording medium and also guides the reflected light from the optical recording medium to the light receiving element, and a base on which the light source, the light receiving element, and optical elements constituting the optical system are mounted; wherein an element holder composed of a photosensitive glass is mounted on the base, the element holder has a positioning portion(s) therein for at least one of the optical elements, and the base has openings therein at locations through which the optical elements can be accessed from the back thereof.

Then, the optical elements can be fixed to the element holder, not to the base.

In the present invention, the positions of the optical elements arranged in the element holder can be precisely adjusted from the back of the base through openings created in the base.

In the present invention, the optical elements can be fixed to the element holder with an adhesive. In such a case, it is desirable that adhesive reservoirs are created by recesses and protrusions on surfaces of the element holder on which an adhesive is applied.

Next, the present invention comprising of a light source, a light receiving element, an optical system that guides light emitted by the light source to an optical recording medium and also guides the reflected light from the optical recording medium to the light receiving element, and a base on which the light source, the light receiving element, and optical elements constituting the optical system are mounted; wherein an element holder composed of an photosensitive glass, which is used for positioning the light source, the light receiving element, and at least one of the optical elements, is mounted on said base; the element holder has a pair of arm frame portions, the inner sides of which have a plurality of positioning surfaces projecting toward the inside, so that the positions of the light source, the light receiving element, and the optical elements in the optical axis direction are determined by the positioning surfaces.

In the optical head device of the present invention, the light source, the light receiving element, and the optical elements are positioned in the precisely manufactured element holder which is composed of a photosensitive glass. Therefore, relative positions among the elements can be determined precisely.

Also, in this case, it is desirable that adhesive reservoirs are created by recesses and protrusions on the surfaces of the element holder, on which adhesive is applied, to bond the optical elements in the element holder.

It is also desirable that a curing treatment by coloring in brown be given as a secondary thermal treatment in order to increase the rigidity of the photosensitive glass element holder.

The positioning surfaces of the element holder may be formed to be perpendicular to a surface of the base on which the element holder is mounted.

To prevent the emitted light or reflected light which is guided to each optical element from being irregularly reflected to be an astray light in the element holder, the element holder may be either made transparent, or a black-colored or non-reflective layer is formed on the surfaces of the element holder.

Embodiments of an optical head device to which the present invention is applied will be described hereinafter, referring to the drawings.

### BRIEF DESCRIPTION OF THE DRAWINGS

FIG. 1 is a cross-sectional view of an optical head device to which the present invention is applied;

FIG. 2 is a perspective view of a light emitting/receiving element in the optical head device of FIG. 1;

FIG. 3 is a perspective view of dissembled optical elements which are to be mounted on a base in the optical head device of FIG. 1;

FIGS. 4(a), (b) and (c) are the diagrams showing the positioning of the light emitting/receiving element, the first and second optical element, and the collimating lens in the element holder;

FIGS. 5(a), (b) and (c) are plan views of the magnified portion of the element holder in which the first optical element is placed;

FIG. 6 is a diagram of a manufacturing process of the element holder;

FIG. 7 is a diagram of the assembling steps of the optical head device of FIG. 1;

FIGS. 8(a), (b) and (c) are diagrams of another example of the element holder of the optical head device of FIG. 1; and

FIGS. 9(a) and (b) are the cross-sectional views of the positioning of the element holder.

### DESCRIPTION OF THE PREFERRED EMBODIMENTS

A. Overall Configuration

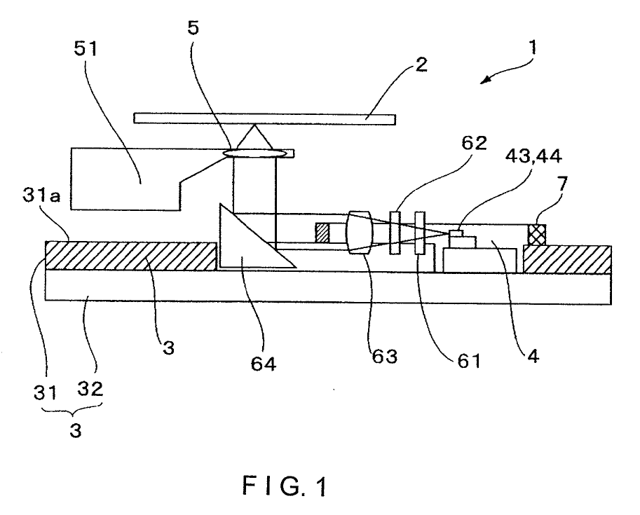

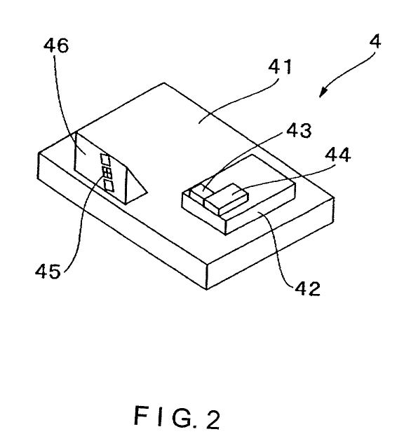

FIG. 1 is a cross-sectional view of an optical head device of this embodiment. FIG. 2 is a perspective view of a light emitting/receiving element in the optical head device of FIG. 1. An optical head device 1 in these figures is a dual wavelength optical head device that uses a laser light of a wavelength of 650 nm bandwidth and a laser light of a wavelength of 780 nm bandwidth. Various elements are mounted on a base 3. The base 3 is constructed such that a wiring board 31 composed of a metal such as aluminum and a metallic base frame 32 are layered on one on the other.

The base 3 is attached to a device frame (not illustrated) having a primary shaft and a secondary shaft that move in the radial direction of the optical recording medium 2. To the device frame, an objective lens driving mechanism is attached to drive an objective lens 5 that converges the emitted laser light onto the optical recording medium 2.

The objective lens driving mechanism has a lens holder 51 for holding the objective lens 5 and a magnetic driving circuit (not illustrated) for supporting the lens holder 51 in the tracking direction and in the focusing direction. By controlling the current to a drive coil that composes the magnetic driving circuit, the objective lens driving mechanism drives the objective lens 5 held in the lens holder 51 in the tracking direction and in the focusing direction with respect to the optical recording medium 2.

A light emitting/receiving element 4 as illustrated in FIG. 2, in which a semiconductor laser chip and a light receiving portion are formed together, is mounted on the base 3. The light emitting/receiving element 4 includes a semiconductor board (PDIC board) 41 which is placed on and bonded on the base 3 with a binder such as a silver paste, a sub mount 42 which is placed on and bonded on the semiconductor board 41, and first and second laser diode chips 43 and 44 respectively which are placed on and bonded on the top surface of the sub mount 42. The first laser diode chip 43 emits a laser light of a wavelength of 650 nm bandwidth, and the second laser diode chip 44 emits a laser light of a wavelength of 780 nm bandwidth.

A light receiving portion 45 for detecting optical signals and a signal computing circuit for processing the signals detected by the light receiving portion 45 are built in the semiconductor board 41. A total reflection mirror 46, which reflects the returning light downward to guide it to the light receiving portion 45, is mounted on the portion of the semiconductor board 41 under which the light receiving portion 45 is built-in. A detecting portion (not illustrated) is built in the sub mount 42 for monitoring the output of the laser light.

A first optical element 61, a second optical element 62, a collimating lens 63, and a direction-changing mirror 64 are arranged on the optical path from the first and second laser diode chips 43 and 44 to the objective lens 5. The first optical device 61 is a wavelength-selective hologram element that can change the optical paths of the incident and reflected rays. The optical device 61 changes the optical path of the light reflected from the optical recording medium 2 to guide it to the total reflection mirror 46 on the light emitting/receiving element 4. The second optical device 62 is a wavelength-selective hologram element that splits the laser light of a wavelength of 780 nm bandwidth, which is emitted by the second laser diode chip 44, into three beams. The direction-changing mirror 64 reflects the emitted laser light, which has been collimated by the collimating lens 63, by 90 degrees to guide it to the objective lens 5.

The optical head device 1 configured as above performs in the following manner: when reproducing the information from DVD as the optical recording medium 2, the laser light of a wavelength of 650 nm bandwidth is emitted by the first laser diode chip 43; when recording the information on CD-R as the optical recording medium 2, the laser light of a wavelength of 780 nm bandwidth is emitted by the second laser diode chip 44. Thus, the recording and reproduction of information on different kinds of optical recording media 2 can be performed.

In this embodiment, the light emitting/receiving element 4, the first optical element 61, the second optical element 62, and the collimating lens 63 are first positioned in the photosensitive glass element holder 7, and then the element holder 7 is mounted on a surface 31 a of the base 3.

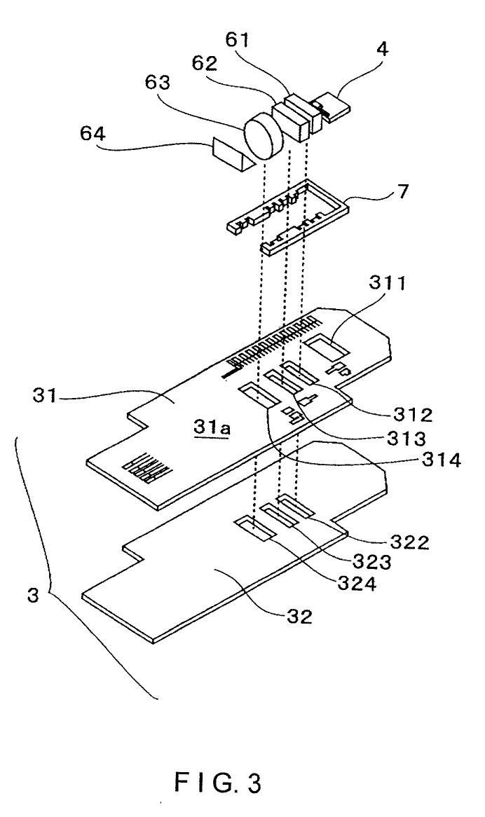

FIG. 3 is a perspective view of the dissembled optical elements which are mounted on the base 3 in the optical head device illustrated in FIG. 1.

As illustrated in the figure, the element holder 7 is formed in such a manner that a flat board is notched in a substantially U-shape; the positioning surfaces are formed in the inner side surfaces of a pair of arm frame portions on the right and left sides so that the light emitting/receiving element 4, the first optical element 61, the second optical element 62, and the collimating lens 63 can be held in predetermined positions and at predetermined angles. The positions of the light emitting/receiving element 4, the first and second optical elements 61 and 62, and the collimating lens 63 in the optical axis direction are automatically adjusted when simply mounted in the element holder 7.

The base 3 is a flat board type member consisting of a metallic wiring board 31, on which a wiring pattern is formed, and a base frame 32 composed of a metallic flat board, which is placed under the wiring board 31. In the wiring board 31, a first opening 311 is formed to position the light emitting/receiving element 4, which is mounted in the positioning element holder. In the same manner, a second opening 312, a third opening 313, and a fourth opening 314 are formed to position the first and second optical elements 61 and 62 and the collimating lens 63.

The second opening 312, the third opening 313, and the fourth opening 314, but not the first opening 311, are connected respectively to a fifth opening 322, a sixth opening 323, and a seventh opening 324 that are formed at the corresponding positions in the base frame 32. Therefore, the first and second optical elements 61 and 62 and the collimating lens 63 positioned in the element holder 7, which is mounted on the surface 31a of the base 3, can be accessed from the back of the base 3.

The light emitting/receiving element 4 is first positioned in the element holder 7 and then directly mounted and fixed onto the surface of the base frame 32 with a silver paste. Due to this, the heat generated by the light emitting/receiving element 4 is released through the base frame 32.

The first optical element 61, the second optical element 62, and the collimating lens 63 are positioned and held in the element holder 7. When the element holder 7 with the elements is mounted onto the surface 31 a of the base 3, the optical elements 61, 62, 63 positioned and held in the element holder 7 can be accessed from the back of the base 3 through the openings (312, 322), (313, 323) and (314, 324). Thus, the position of each of the optical elements 61, 62, 63 can be precisely adjusted using a tool through the openings.

B. Element Holder for Positioning

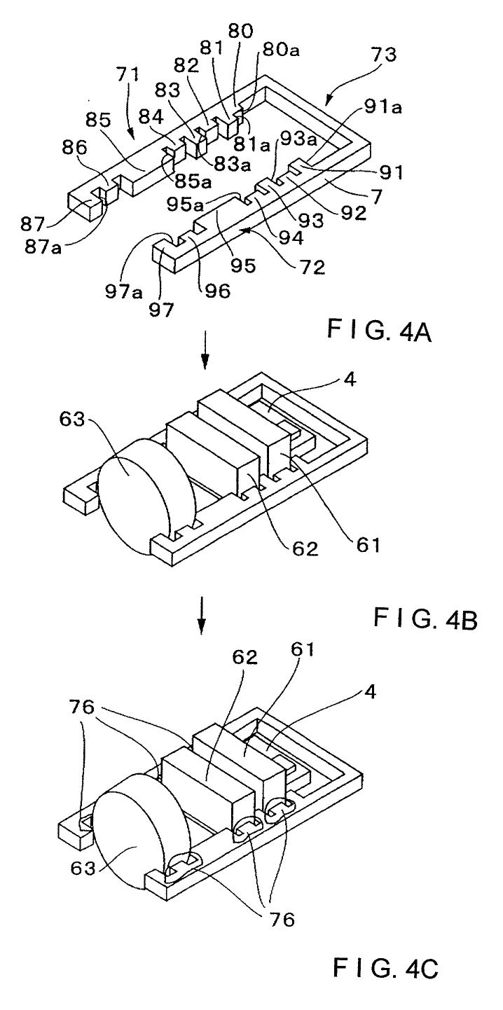

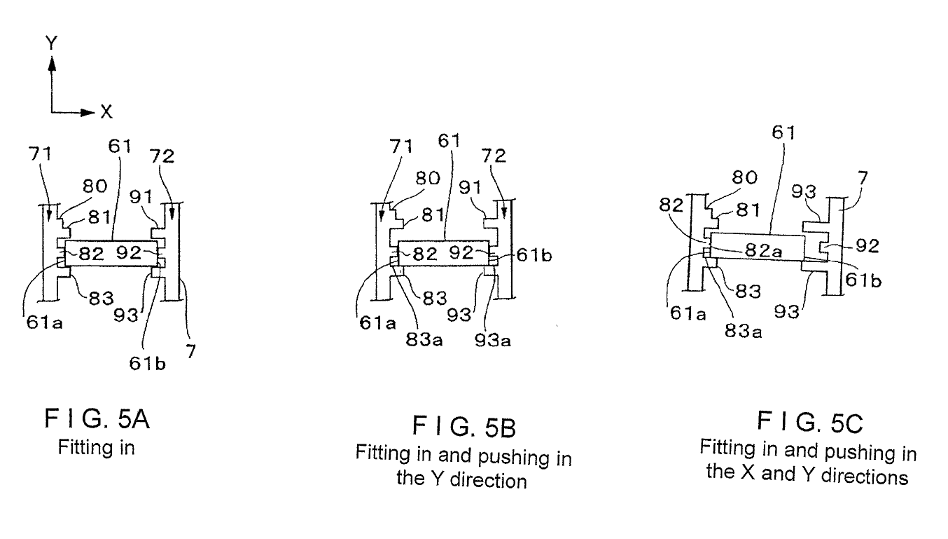

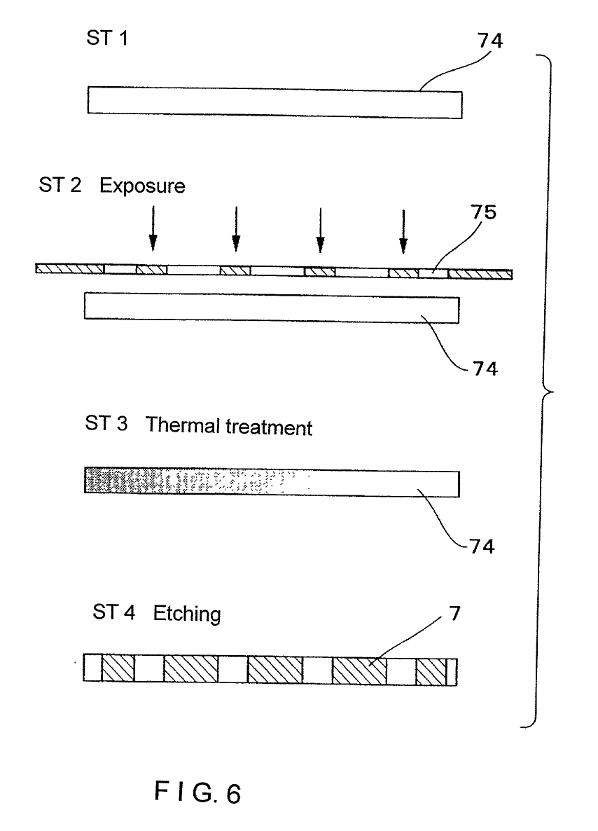

Next, the configuration of the element holder for positioning 7 will be described in detail. FIGS. 4(a), (b) and (c) show how the light emitting/receiving element 4, the first and second optical elements 61 and 62, and the collimating lens 63 are positioned in the element holder 7 of the optical head device 1 of this embodiment. FIGS. 5(a), (b) and (c) are the magnified plan views of the portion of the element holder 7 in which the first optical element 61 is fitted. FIG. 6 is a diagram of a manufacturing process of the element holder 7. Note that the base 3, on which the element holder 7 is fixed, is omitted in FIGS. 4 and 5 to make it easier to understand.

First, as illustrated in FIG. 4(a), the substantially U-shaped element holder 7 has a pair of arm frame portions 71 and 72 on the right and left sides and a joining frame portion 73 that connects the arm frame portions 71 and 72 at the rear ends. On the inner side surfaces of a pair of the arm frame portions 71 and 72, the positioning portions for positioning the light emitting/receiving element 4, the first and second optical elements 61 and 62, and the collimating lens 63 in the optical axis direction are formed by a plurality of protrusions that project upright from the inner side surfaces toward the inside.

In other words, first through seventh protrusions 81 through 87, starting from the joining frame portion 73 side, are formed on one of a pair of the inner side surfaces, and first through seventh protrusions 91 through 97 are formed at the corresponding positions on the inner side surface on the other side. An eighth protrusion 80 is additionally formed in one of the inner side surfaces. The rear end surfaces 81a and 91a of the protrusions 81 and 91 are the positioning surface for the light emitting/receiving element 4 in the optical axis direction, and the inner side surface 80a of the protrusion 80 is the positioning surface for the light emitting/receiving element 4 in the direction perpendicular to the optical axis. The rear end surfaces 83a and 93a of the protrusions 83 and 93 are the positioning surfaces for the first optical element 61 in the optical axis direction, and the rear end surface 85a and 95a of the protrusions 85 and 95 are the positioning surface for the second optical element 62 in the optical axis direction. Further, the rear end surfaces 87a and 97a of the protrusions 87 and 97 are the positioning surfaces for the collimating lens 63 in the optical axis direction. FIG. 4(b) shows that the optical elements 61, 62 and 63 are positioned in the element holder 7.

When each optical element 61, 62, 63 is positioned and pushed toward each positioning surface in the optical axis direction, the positions thereof in the optical axis direction are determined. The positional adjustments of the elements in the direction perpendicular to the optical axis and around the optical axis can be made from the back of the base 3, as described above.

After the position of each of the optical elements is adjusted, the first and second optical elements 61 and 62 and the collimating lens 63 are bonded to the element holder 7 with a photosensitive adhesive. Code 76 in FIG. 4(c) indicates the adhesive filling portions.

Three forms of the structure for fixing the positions of the first and second optical elements 61 and 62 and the collimating lens 63, which are positioned in the element holder 7, will be described. Note that the first optical element 61 is used as an example to describe these forms, referring to FIG. 5.

In the form illustrated in FIG. 5(a), the optical element 61 is fitted between the adjacent protrusions 81, 83 and 91, 93 on the right and left arm frame portions 71 and 72 so that the position thereof in the optical axis direction, Y, is automatically determined. At the same time, when the optical element 61 is fitted between a pair of protrusions 82 and 92, the positioning thereof in the direction, X, which is perpendicular to the optical axis, is also automatically determined.

It is preferred that the positioning surface of each of the protrusions 81 through 83 and 91 through 93 be determined to be the plane perpendicular to the base surface, which is parallel to the optical axis, so that the optical element 61 can be positioned without leaning toward the optical axis.

Two grooves are created between each pair of the adjacent protrusions 81 through 83 and also between each pair of the adjacent protrusions 91 through 93. Therefore, when an adhesive agent is filled between the optical element 61 and each of the arm frame portions 71 and 72, the grooves function as adhesive reservoirs so that the optical element 61 can be firmly bonded to the right and left arm frame portions 71 and 72.

In the form illustrated in FIG. 5(b), the positioning of the optical element 61 in the direction, X, which is perpendicular to the optical axis, is automatically completed by the right and left protrusions 82 and 92. However, the positioning of the element in the optical axis direction, Y, is done by pushing the optical element 61 to the rear end surfaces 83a and 93a of the right and left protrusions 83 and 93. Even with this form, the adhesive reservoirs are created between each of the adjacent protrusions 82 and 83 with the end surface 61 a of the optical element and also between the protrusions 92 and 93 with the end surface 61b of the optical element. Thus, the optical element 61 can be firmly bonded to the element holder 7.

In the form illustrated in FIG. 5(c), the positioning of the element in the optical axis direction, Y, is done by pushing the optical element 61 to the rear end surfaces 83a and 93a of the right and left protrusions 83 and 93 while the positioning in the direction, X, which is perpendicular to the optical axis, is done by pushing the optical element 61 to the inner side surface 82a of the protrusion 82. Even with this form, the adhesive reservoir is created between the protrusions 82 and 83 with the optical element end surface 61a. Thus, the optical element 61 can be firmly bonded to the element holder 7.

Note that, as illustrated in FIG. 6, the positioning element holder 7 in the above shape is manufactured by a photo lithographic technique. As illustrated in the figure, a flat photosensitive glass 74 is first prepared in Step ST1. The thickness of the glass is 1.0 mm. In Step 2, a photo mask 5, which is cut out according to the recess-protrusion shape for the element positioning, is prepared to cover the surface of the photosensitive glass 4. Under this condition, a light such as a UV light is illuminated on the glass 4 through the photo mask 5. After a thermal treatment in Step ST3, the portions on which the light is illuminated are removed by using an etching solution of a fluoric acid. Then, each element holder 7 is cut out from the photosensitive glass 74.

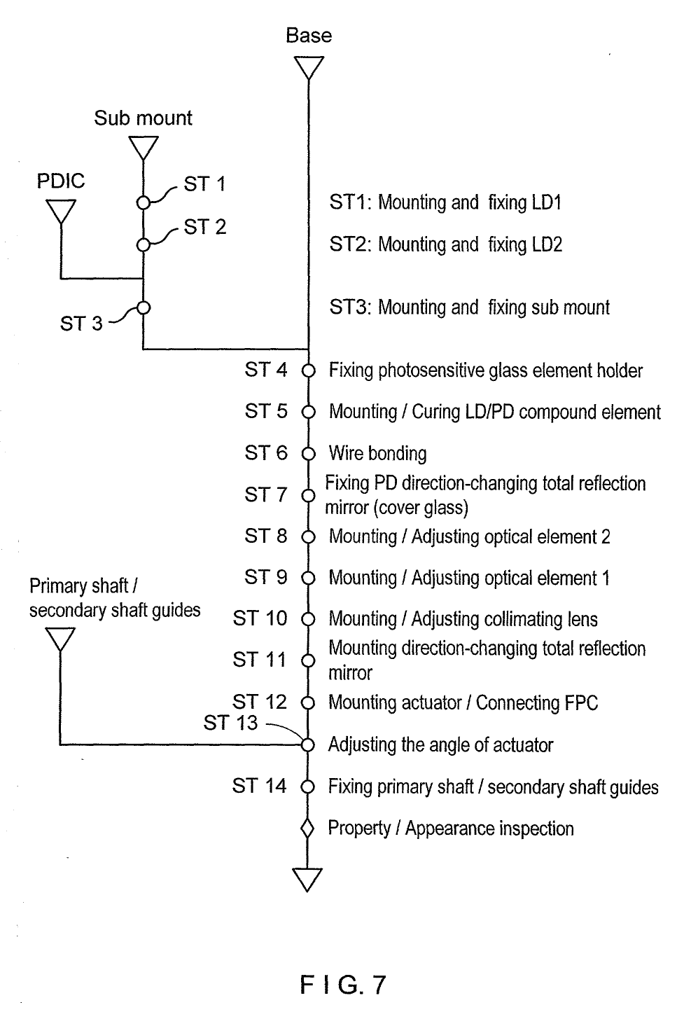

Next, the process of assembling the optical head device 1 of this embodiment will be described, as in FIG. 7. A base 3 on which a wiring board 31 and a base frame 32 are already layered is prepared, and necessary electronic components are mounted thereto. Meanwhile, a sub mount 42 on which semiconductor laser chips 44 and 43 are mounted and fixed is prepared (Steps ST1 and ST2), and mounted and fixed on a semiconductor substrate (PDIC) 41, in which an integrated circuit including a light receiving portion 45 for signal reproduction and a signal computing circuit is built, to manufacture the light emitting/receiving element 4 (Step ST3).

Then, an element holder 7 is fixed to the base 3, and the light emitting/receiving element 4 is mounted and fixed (Steps ST4 and ST5). An electrode portion of the light emitting/receiving element 4 and an electrode terminal formed on the wiring board 31 are connected through a bonding wire (Step ST6). Then, a covering case, to which a total reflection mirror 46 is attached, is placed over the light receiving portion 45 of the light emitting/receiving element 4 and then bonded to it (Step ST7).

Next, the first and second optical elements 61 and 62 and the collimating lens 63 are placed in the element holder 7 which is fixed to the base 3. After adjusting the optical positions of the optical elements 61 and 62, these elements are bonded to the element holder 7. (Steps ST8, ST9, and ST10).

After a direction-changing mirror is attached to the base 3 (Step ST11), an objective lens driving mechanism (actuator) is mounted onto a device frame (not illustrated) on which the base 3 is mounted. A flexible printed board is then soldered to a terminal for supplying electricity to a driving coil, etc, and then the angle of the lens holder 51, in which the objective lens 5 is fixed, is adjusted (Steps ST12 and ST13). After adjusting the angle of the lens holder, the primary and secondary shaft guides of the device frame are fixed (Step ST14). The assembling of the optical head device 1 is then completed after a property inspection and an appearance inspection.

As described above, in the optical head device 1 of this 5 embodiment, the optical elements can be easily positioned by mounting them in the element holder 7. The element holder 7 is composed of a photosensitive glass, so that it can be manufactured with high precision. Also, in the base 3 on which the element holder 7 is to be mounted, the portions wherein the optical elements are to be placed are made as through holes. Therefore, the positions of the optical elements which are mounted in the element holder 7 can be precisely adjusted from the back of the base. Thus, the optical elements can be positioned with high precision.

Further, since the element holder 7 is formed such that the surfaces thereof for fixing the optical elements are recessed and protruded, the recess portions function as the adhesive reservoirs which increase the adhesiveness between the element holder 7 and the optical elements.

C. Another Embodiment of the Element Holder

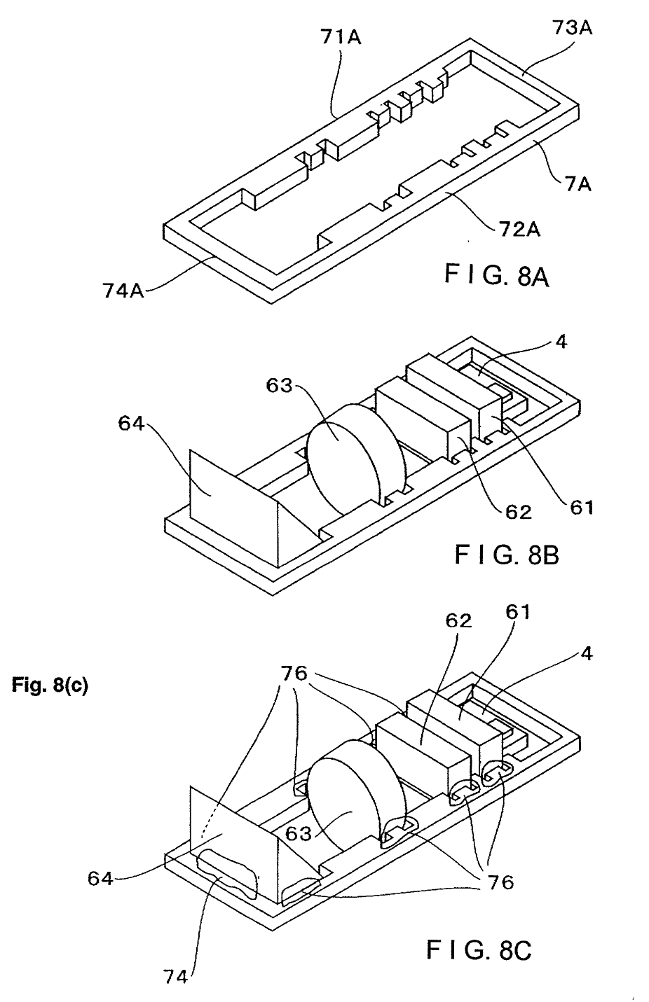

The above described element holder 7 is used for positioning the light emitting/receiving element 4, the first and second optical elements 61 and 62, and the collimating lens 63. However, the right and left arm frame portions of the element holder 7 may be extended to create a positioning portion for the direction-changing mirror 64 at the end portion of the arms. FIGS. 8(a), (b), and (c) are diagrams of an element holder that has the positioning portion for the direction-changing mirror 64. This element holder can be substituted for the above described element holder 7.

As illustrated in FIG. 8(a), the element holder 7A of this embodiment is rectangle as a whole. The holder 7A has a pair of longer side frame portions 71A and 72A and a pair of shorter side frame portions 73A and 74A that respectively connect the front and back ends of the longer side frame portions 71A and 72A. Each of a pair of inner side surfaces of the longer side frame portions 71A and 72A is provided with recesses and protrusions, which are formed by a photo lithographic technique, for positioning the light emitting/receiving element 4, the first and second optical elements 61 and 62, the collimating lens 63, and the direction-changing mirror 64, in this order starting from the shorter side frame portion 73A.

As illustrated in FIG. 8(b), the light emitting/receiving element 4, the first and second optical elements 61 and 62, the collimating lens 63, and the direction-changing mirror 64 are placed in the predetermined positions in the element holder 7A. The positions of the first and second optical elements 61 and 62, the collimating lens 63, and the direction-changing mirror 64 are adjusted based on the optical axis of the light emitting/receiving element 4, which is fixed on the base frame 32 of the base 3.

After the positional adjustments, the first and second optical elements 61 and 62, the collimating lens 63, and the direction-changing mirror 64 are bonded to the element holder 7A with the photosensitive adhesive 76, as illustrated in FIG. 8(c).

Next, the photosensitive glass element holder 7, 7A may be given a curing treatment through a secondary thermal treatment. A curing treatment can increase the rigidity of the element holder 7, 7A. Also, the photosensitive glass element holder turns brown through a secondary thermal treatment.

For the element holder which is colored brown through a secondary thermal treatment performed to increase the rigidity of the adhesive, it is desirable to have a countermeasure for astray light. For this reason, the surface of the element holder may be colored black, or a non-reflective layer is applied on the surface, which serves as an astray light countermeasure.

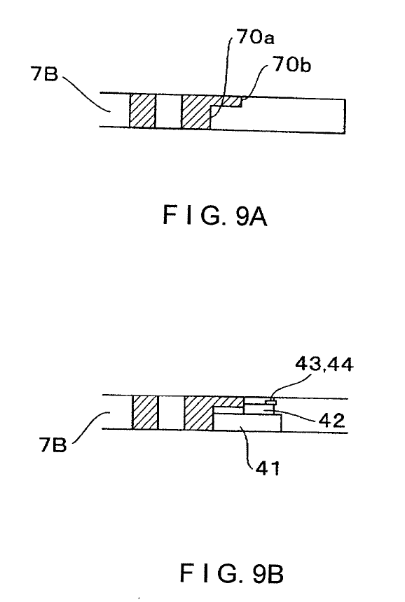

The positioning surfaces to be formed in the element holder 7, 7A may be created by a half etching process. For example, as illustrated in FIG. 9(a), the positioning surfaces formed in an element holder 7B are formed in a step-like cross-section in the thickness direction by a half-etching process. A first positioning surface 70a and a second positioning surface 70b projecting like a step from the first positioning surface 70a are also formed in the same manner. As illustrated in FIG. 9(b), the sub mount 42 and the semiconductor substrate 41 are pushed to the positioning surfaces 70a and 70b to position the light emitting/receiving element 4.

As described above, the optical head device of the present invention is configured such that an element holder composed of a photosensitive glass is used for positioning the optical elements and a base, on which the element holder is mounted, has openings created at portions thereof where the optical elements positioned in the element holder can be accessed from the back of the base. Thus, since the positions of the optical elements in the element holder which is manufactured with high precision can be precisely adjusted from the back of the base, the optical elements can be positioned with high precision.

Further, the element holder has adhesive reservoirs at the positioning portions thereof for positioning the optical elements. Therefore, the optical elements can be firmly bonded to the element holder.

While the foregoing description and drawings represent the present invention, it will be obvious to those skilled in the art that various changes may be made therein without departing from the true spirit and scope of the present invention.

What is claimed is:

1. An optical head device comprising:
a light source;
a light receiving element;
an optical system that guides light emitted by said light source to an optical recording medium and also guides said light reflected from said optical recording medium to said light receiving element; and
a base on which said light source, said light receiving element, and optical elements constituting said optical system are mounted;
wherein an element holder composed of a photosensitive glass is mounted on said base; said element holder has a positioning portion(s) therein for at least one of said optical elements; and said base has openings therein at locations through which said optical elements can be accessed from the back thereof.

2. The optical head device as set forth in claim 1 wherein said optical elements are fixed to said element holder, not to said base.

3. The optical head device as set forth in claim 1 wherein said optical elements are fixed to said element holder with an adhesive, and adhesive reservoirs created by recess and protrusions are formed on surfaces of said element holder on which an adhesive is applied.

4. An optical head device comprising:
a light source;
a light receiving element;
an optical system that guides light emitted by said light source to an optical recording medium and also guides said light reflected from said optical recording medium to said light receiving element; and
a base on which said light source, said light receiving element, and optical elements constituting said optical system are mounted;
wherein an element holder composed of an photosensitive glass, which is used for positioning said light source, said light receiving element, and at least one of said optical elements, is mounted on said base; said element holder has a pair of arm frame portions, the inner sides of which have a plurality of positioning surfaces projecting toward the inside, so that the positions of said light source, said light receiving element, and said optical elements in the optical axis direction are determined by said positioning surfaces.

5. The optical head device as set forth in claim 4 wherein said optical elements are fixed to said element holder with an adhesive; and adhesive reservoirs created by recess and protrusions are formed in said adhesive applying surfaces of said element holder.

6. The optical head device as set forth in claim 4 wherein said element holder is cured.

7. The optical head device as set forth in claim 4 wherein said positioning surfaces of said element holder are perpendicular to a surface of said base on which said element holder is mounted.

8. The optical head device as set forth in claim 4 wherein said element holder is transparent.

9. The optical head device as set forth in claim 4 wherein a black-colored or non-reflective layer is formed on said surfaces of said element holder.
